(19) United States
(12) Patent Application Publication
(10) Pub. No.: US 2022/0124881 A1
(43) Pub. Date: Apr. 21, 2022

(54) Wireless Temperature Sensing for Closed-Loop Cooking Control

(71) Applicant: Creator, Inc., San Francisco, CA (US)

(72) Inventors: Michael BALSAMO, San Francisco, CA (US); Cameron BENNETT, San Francisco, CA (US); Jeff C. JENSEN, San Francisco, CA (US); Noe ESPARZA, San Francisco, CA (US); Steven FREHN, San Francisco, CA (US); Wayne GROUT, Oakland, CA (US); Maxwell GOODMAN, Oakland, CA (US); Molly HOELPER, San Carlos, CA (US); Andrew STULC, Spokane, WA (US); Larry G. KISER, Fremont, CA (US); Leo AMAR, Paris (FR)

(21) Appl. No.: 17/503,306

(22) Filed: Oct. 16, 2021

Related U.S. Application Data
(60) Provisional application No. 63/093,132, filed on Oct. 16, 2020.

(51) Int. Cl. H05B 6/06; H05B 6/12; H05B 6/10; H04B 5/00

(52) U.S. Cl. CPC H05B 6/062; H05B 6/1236; H05B 2213/07; H04B 5/0043; H05B 6/105

(57) ABSTRACT

A temperature sensing device for a heating surface for food products includes a temperature probe configured to be coupled to the heating surface and to generate an electrical signal indicative of a temperature of the heating surface. The device includes a controller in electrical communication with the temperature probe. The device includes a wireless transmitter in electrical communication with the controller. The controller is configured to read the electrical signal from the temperature probe and to provide an output signal to the wireless transmitter. The wireless transmitter is configured to wirelessly transmit a temperature signal to a transceiver based on the output signal. The wireless transmitter is configured to wirelessly receive energy. The controller is configured to be powered by the received energy from the wireless transmitter.

### CROSS-REFERENCE TO RELATED APPLICATIONS

This application claims the benefit of U.S. Provisional Application No. 63/093,132 filed Oct. 16, 2020, the entire disclosure of which is incorporated by reference.

### FIELD

The present disclosure relates to systems and methods for wireless temperature sensing for use in closed-loop control of food heating.

### BACKGROUND

While various temperature sensors may be used to measure the temperature of a cooking surface for use in closed-loop cooking control, such sensors may be susceptible to the heat and contaminants present in a cooking environment. As such, temperature sensing for closed-loop cooking control is subject to improvement.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A temperature sensing device for a heating surface for food products includes a temperature probe configured to be coupled to the heating surface and to generate an electrical signal indicative of a temperature of the heating surface. The device includes a controller in electrical communication with the temperature probe. The device includes a wireless transmitter in electrical communication with the controller. The controller is configured to read the electrical signal from the temperature probe and to provide an output signal to the wireless transmitter. The wireless transmitter is configured to wirelessly transmit a temperature signal to a transceiver based on the output signal. The wireless transmitter is configured to wirelessly receive energy. The controller is configured to be powered by the received energy from the wireless transmitter.

In other features, the wireless transmitter is configured to, while the heating surface is in a first location, selectively wirelessly transmit the temperature signal to the transceiver and selectively wirelessly receive energy from a first power source. The wireless transmitter is configured to, while the heating surface is in a second location, selectively wirelessly transmit the temperature signal to a second transceiver and selectively wirelessly receive energy from a second power source.

A food heating system includes the temperature sensing device, the heating surface, the transceiver, and the second transceiver. The transceiver is located proximate to the first location. The second transceiver is located proximate to the second location. In other features, the transceiver is configured to operate as the first power source. The second transceiver is configured to operate as the second power source. In other features, the food heating system includes a first inductive energy generator configured to selectively heat the heating surface while the heating surface is in the first location and a second inductive energy generator configured to selectively heat the heating surface while the heating surface is in the second location.

In other features, the first inductive energy generator is configured to operate as the first power source. The second inductive energy generator is configured to operate as the second power source. In other features, the wireless transmitter is configured to wirelessly receive the energy from the transceiver. In other features, the heating surface is heated by an inductive energy source. The wireless transmitter is configured to wirelessly receive the energy from the inductive energy source.

In other features, the wireless transmitter includes a near-field communication (NFC) tag. In other features, the wireless transmitter includes an antenna that is configured to be inductively excited by an electromagnetic field generated by one of the transceiver and an inductive energy generator. The received energy is based on a voltage generated by the inductive excitation of the antenna. In other features, the temperature sensing device includes an energy storage device configured to temporarily store at least a portion of the received energy. In other features, the energy storage device includes at least one of a battery and a capacitor.

In other features, the temperature sensing device includes a frame configured to mechanically couple to the heating surface. The frame supports the controller and the wireless transmitter. In other features, an exterior of the frame defines a three-dimensional volume and the controller and the wireless transmitter are contained within the three-dimensional volume. In other features, the temperature sensing device includes a heat-resistant gasket disposed on a surface of the frame between the heating surface and the surface of the frame. In other features, a portion of the frame adjacent to the heating surface includes a recessed pocket configured to hold a heat-resistant material.

In other features, the frame has a bore extending through one face of the frame. The bore is configured to allow the temperature probe to pass through the frame and into an opening in the heating surface. In other features, the frame is made of at least one of a metal material and a heat-resistant material. In other features, the temperature sensing device includes a heat-resistant, non-metallic board disposed within the frame. The board is configured to attach to the frame and to support the controller and the wireless transmitter within the frame.

In other features, the controller, the wireless transmitter, and the board are encapsulated in a radio-wave-transparent material. In other features, the radio-wave-transparent material includes at least one of silicone rubber and a polyetherimide (PEI) thermoplastic. In other features, the controller includes at least one of a processor, a microcontroller, and a system on a chip.

In other features, the controller and the wireless transmitter are disposed together on a substrate. The wireless transmitter includes an antenna. The antenna is formed as one or more electrical traces on the substrate that extend along an outer perimeter of the substrate. In other features, the controller is configured to read the electrical signal at a defined sampling rate. In other features, the controller is configured to dynamically adjust the defined sampling rate.

In other features, the temperature sensing device includes an accelerometer. The controller is configured to (i) determine an orientation of the heating surface based on data from the accelerometer and (ii) control the wireless transmitter to wirelessly transmit information to the transceiver that indicates the determined orientation. In other features, the temperature probe includes at least one of a thermistor and a resistance temperature detector.

A heating apparatus includes the temperature sensing device and the heating surface. The heating surface is configured to be heated by an external energy source. In other features, the heating surface includes a ferrous metal material. The heating surface includes a channel extending into the ferrous metal material that receives the temperature probe. In other features, the heating surface is configured to be heated by electromagnetic induction excited by an inductive energy generator. In other features, the wireless transmitter includes an antenna configured to be excited by the inductive energy generator. The excitation of the antenna produces the received energy.

In other features, the temperature probe is most sensitive to temperature changes at a measurement region of the temperature probe. The channel extends to dispose the measurement region of the temperature probe adjacent to a location on the heating surface where a largest eddy current flows in the heating surface during the electromagnetic induction. In other features, the channel is filled with a thermal paste configured to make a thermal connection between the temperature probe and the heating surface. In other features, the heating surface includes an aluminum-clad stainless steel material. In other features, the heating surface includes a polytetrafluoroethylene (PTFE) coating on at least one side of the heating surface.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a schematic diagram of an example food preparation system with a wireless temperature sensing module;

FIG. 2 is a plan view of a platen assembly;

FIG. 3A is a side view of hot plates in an open position;

FIG. 3B is a side view of the hot plates in a closed position;

FIG. 4 is a side view of the example food preparation system;

FIG. 5 is a perspective view of the example food preparation system;

FIG. 6 is a schematic diagram of the griddle module with heating modules and transceivers;

FIG. 7 is a side view of a platen assembly connection to the example food preparation system;

FIG. 8 is a side view of another example food preparation system;

FIG. 9 is a side view of yet another example food preparation system;

FIG. 10 is a side view of another platen assembly; and

FIG. 11 is a side view of yet another platen assembly.

In the drawings, reference numbers may be reused to identify similar and/or identical elements.

### DETAILED DESCRIPTION

To regulate cooking of a food item, such as by performing closed-loop control on a cooking temperature or on a calculated heat transfer to the food item, the temperature of a cooking surface may be measured. Contact temperature sensors and non-contact temperature sensors, such as infrared or laser thermometers, may be used to measure the temperature of the cooking surface. However, non-contact sensors may rely on a line of sight to measure the temperature and may not accurately measure the temperature of a moving cooking surface or a cooking surface where a food item blocks the line of sight between the temperature sensor and the cooking surface. Problems may also occur in sensors on or near the cooking surface, as such sensors may be susceptible to contaminants in the cooking environment such as food, water, grease, and cleaning chemicals. Further, sensors exposed to high temperatures in the cooking environment may have reliability, longevity, and accuracy problems. For moving cooking surfaces, wired sensors may require additional hardware such as slip rings, cable control (including cable suspension and strain relief), and/or other electrical contacts to transmit measurements from a moving temperature sensor to a controller. Such additional hardware may also be susceptible to the contaminants and heat in a cooking environment.

The wireless temperature sensing module described in the following disclosure endeavors to solve the problems of the related technology, including: positioning a temperature probe in a more ideal location for measuring temperature; measuring the temperature of a cooking surface that can translate and/or rotate from one position to another; eliminating wired contacts between the temperature sensing module and a cooking controller; and protecting the electronics used in wireless temperature sensing from both heat and substances common in a cooking environment, such as food, grease, water, and cleaning chemicals. Integrating a temperature probe with an existing cooking surface and combining the cooking surface with a wireless temperature sensing module may allow existing hardware in a food preparation system to be modified, without having to retrofit additional hardware to a cooking system.

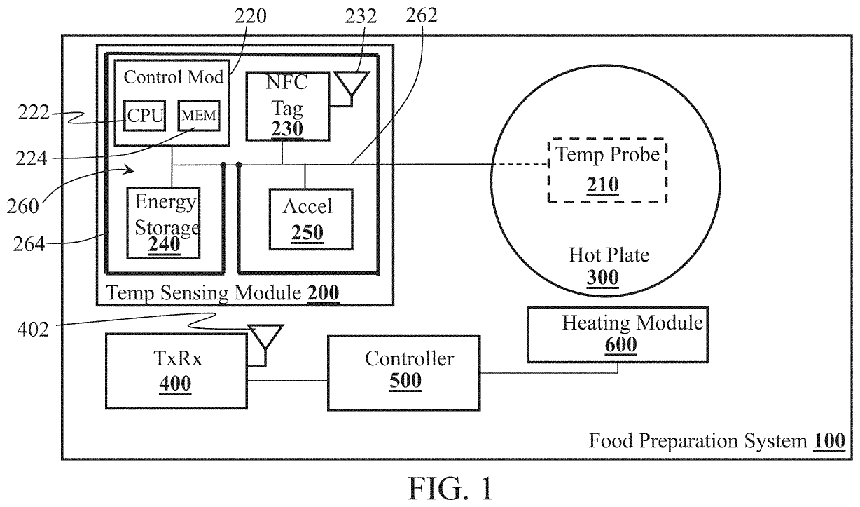

FIG. 1 illustrates a schematic diagram of food preparation system 100 including a wireless temperature sensing module 200. The wireless temperature sensing module 200 may be connected to a hot plate 300, with portions of the wireless temperature sensing module 200 embedded in the hot plate 300 to provide a temperature measurement of the hot plate 300 while the hot plate 300 is in use. For example, the wireless temperature sensing module 200 may be used to measure the temperature of the hot plate 300 while the hot plate 300 cooks a food item, and the wireless temperature sensing module 200 may then wirelessly transmit the temperature of the hot plate 300 to an external transceiver 400 for use by a cooking controller 500 in closed-loop cooking control. Measured temperatures of the hot plate 300 may be transmitted wirelessly from the wireless temperature sensing module 200 to the transceiver 400 for use by a cooking controller 500 to control the heating module 600 to regulate the temperature of the hot plate 300.

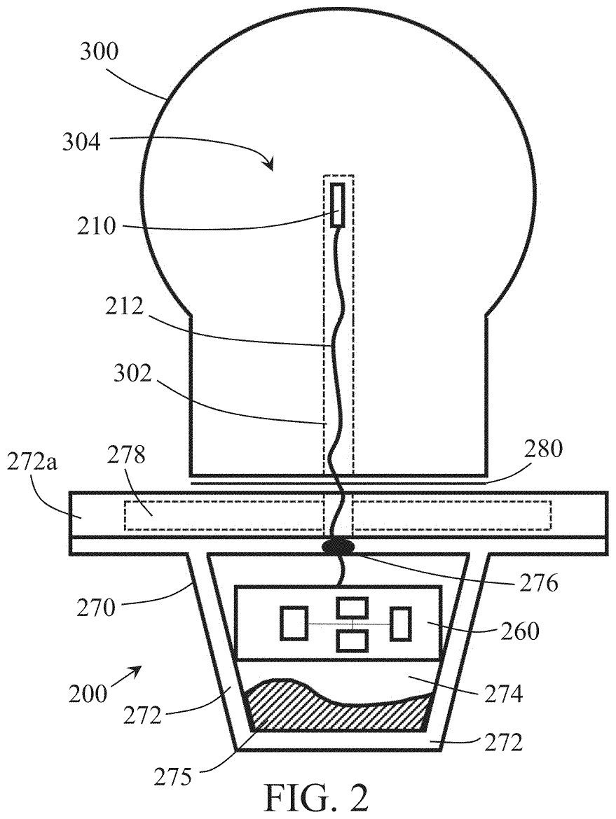

FIG. 2 shows a perspective view of the wireless temperature sensing module 200 and the hot plate 300. The wireless temperature sensing module 200 may be configured to attach to the hot plate 300 to form a single platen assembly. The wireless temperature sensing module 200 and hot plate 300 assembly may also be referred to as a platen assembly.

The wireless temperature sensing module 200 may include a temperature probe 210, a control module 220, a near-field communication (NFC) tag 230, an energy storage device 240, an accelerometer 250, a substrate 260, and a frame 270.

The hot plate 300 may be configured to embed the temperature probe 210 within a channel 302 in the hot plate 300, so that the temperature probe 210 can measure the temperature of the hot plate 300 while the hot plate 300 is in use.

The temperature probe 210 may be temperature sensor that varies a resistance value based on the temperature of the hot plate 300. For example, the temperature probe 210 may be a thermistor.

A thermistor temperature probe 210 may have a negative temperature coefficient (NTC) where the resistance value of the temperature probe 210 decreases as the temperature of the hot plate 300 increases.

Alternatively, a thermistor temperature probe 210 may have a positive temperature coefficient (PTC) where the resistance value of the temperature probe 210 increases as the temperature of the hot plate 300 rises.

In another example, the temperature probe 210 may be a resistance temperature detector (RTD). Similar to a thermistor, an RTD temperature probe 210 uses a resistance and a temperature relationship to accurately measure a temperature of the hot plate 300.

While a singular temperature probe 210 is shown embedded in the hot plate 300 in the example embodiment of the wireless temperature sensing module 200, other embodiments of the wireless temperature sensing module 200 may include a plurality of temperature probes 210 embedded in a hot plate 300. For example, different types of the above-described temperature probe 210 examples may be embedded in a hot plate 300.

The temperature probe 210 is wired to the control module 220 via a wire 212. Temperature measurements from the temperature probe 210 may be transmitted to the control module 220 via the wire 212. In instances where the temperature probe 210 requires power to make a temperature or resistance measurement, the wire 212 may be used to transmit power from the control module 220 to the temperature probe 210.

The control module 220 may be a small computing device such as a microcontroller or a system on a chip (SoC). With reference again to FIG. 1, the control module 220 may include processor hardware 222, memory hardware 224, and input/output (I/O) peripherals (not shown). The control module 220 may further include a temperature sensing device to monitor the temperature of the control module 220 to ensure the control module 220 is operating within a normal operating temperature range and not exposed to high temperatures that may cause damage to the control module 220. The control module 220 is electrically connected to the temperature probe 210, the NFC tag 230, the energy storage device 240, and accelerometer 250. The control module 220 may be configured to process inputs and outputs from the temperature probe 210, the NFC tag 230, the energy storage device 240, and the accelerometer 250.

The processor hardware 222, may be used to execute programs or instruction sets stored in the memory hardware 224. The execution of a program can instruct the control module 220, and more generally the temperature sensing module 200, to perform a specific task. For example, a program executed by the processor hardware 222 may instruct the control module 220 to acquire a measurement from the temperature probe 210 and to control the NFC tag 230 to wirelessly transmit the acquired measurement to the external transceiver 400.

The control module 220 may use the memory hardware 224 for storing programs and data. The memory hardware 224 may be used to store calibration data for calibrating the temperature probe 210. The memory hardware 224 may also be used to store a unique identifier of the control module 220. For example, when a plurality of wireless temperature sensing module 200 are used, the unique identifiers may be used for inventory control and performance tracking of the plurality of control modules 220.

The control module 220 may also be configured to execute programs at a predefined interval or frequency. For example, a program executed by the control module 220 may cause the control module 220 to have a sampling rate of ten Hertz (10 Hz) that captures a temperature measurement from the temperature probe 210 every tenth of a second (0.1 s), or rather, at a rate of 10 samples per second. The firmware of the control module 220 may be controlled to allow for full software stack time to ensure consistent control loop operation at a sufficient rate to efficiently regulate the temperature of the hot plate 300. The control module 220 may also have a variable sampling rate.

The control module 220 may be further configured to process measurements from the temperature probe 210 to convert the measurements from the temperature probe 210 into another value. For example, if the temperature probe 210 changes resistance relative to the temperature of the hot plate 300, a resistance value corresponding to a certain temperature may be input to the control module 220. The control module 220 may further process the resistance value, for example using a program, computation, or lookup table, to output a corresponding temperature value measured in units of Kelvin, Celsius, or Fahrenheit. Generally, the control module 220 may apply a signal processing technique to any measurement or temperature signal from the temperature probe 210. Alternatively, the control module 220 may output any raw measurements by the temperature probe 210 as is (i.e., as raw data), and wirelessly transmit the raw measurements via the NFC tag 230 without any further processing.

The control module 220 may also be configured to manage the power of the temperature sensing module 200. For example, where the temperature sensing module 200 is configured to receive wireless power transfers through the NFC tag 230, the control module 220 may direct control the flow of received power to the energy storage device 240. In this example, the control module 220 may be configured to function as a charge controller to control the charging of the energy storage device 240. The control module 220 may also monitor the power consumption of the temperature probe 210, the NFC tag 230, the accelerometer 250, and the control module 220 itself, relative to the charge level of the energy storage device 240. In this way, the control module 220 may monitor the power consumption of the elements in the temperature sensing module 200 to ensure that the energy storage device 240 has enough stored power to power the elements. In instances where the control module 220 detects a low charge level in the energy storage device 240, the control module 220 may further regulate which of the temperature probe 210, the NFC tag 230, the accelerometer 250, and the control module 220 may draw power from the energy storage device in order to conserve the power from the energy storage device 240.

The NFC tag 230 is a transceiver configured to send and receive wireless communications using an NFC communication protocol to/from the external transceiver 400, in addition to receiving wireless power from the external transceiver 400. As such, the NFC tag 230 may be configured to modulate and demodulate signals prior to sending signals and after receiving signals. Near-field communications may include communications within a range of zero to twenty centimeters (0-20 cm). For example, the NFC tag 230 may be spaced apart from the external transceiver 400 at a distance of one to four centimeters (1-4 cm). The NFC tag 230 may be, for example, a radio-frequency identification (RFID) tag. While one example embodiment includes an RFID NFC tag 230, other NFC tag 230 examples include simple resonators or transceivers operating on a Bluetooth low energy (LE) standard.

The NFC tag 230 can inductively couple with the external transceiver 400 to wirelessly transmit power from the external transceiver 400 to the NFC tag 230. The external transceiver 400 may include a primary winding such as a loop antenna 402, where a time varying current passing through the loop antenna 402 generates a magnetic field. The magnetic field generated by the external transceiver 400 can induce an electromagnetic force, i.e., voltage, in a secondary winding of the NFC tag 230. The NFC tag 230 includes a loop antenna 232 as the secondary winding in which a voltage may be induced. That is, the loop antenna 232 receives magnetic inductance from which the voltage may be induced. In this regard, the external transceiver 400 and the NFC tag 230 function similar to transformer, where a time varying current flowing through the loop antenna 402 (i.e., a primary winding) of the external transceiver 400 generates a magnetic field that can induce a voltage of in the loop antenna 232 (i.e., a secondary winding) of the NFC tag 230. The loop antenna 402 and loop antenna 232 may be tuned based on a combination of resistor and capacitors. Mutual inductance between the external transceiver 400 and the NFC tag 230 may be derived, for example, using Maxwell's equations, flux linkage, Ampere's law, Faraday's law of induction, and other laws and equations. The external transceiver 400 and the NFC tag 230 may be configured to measure the variables used in such laws and equations so that the control module 220 can process the measurements using the laws and equations to compute a mutual inductance value between the external transceiver 400 and the NFC tag 230. The mutual inductance value may be used to detect the position of the NFC tag 230 relative to the transceiver 400 (e.g., in an optimal position for transmitting/receiving RF communications and power coupling), as well as being used to measure the quality of the power coupling.

The voltage induced in the NFC tag 230 has an alternating current (AC). That is, the AC voltage has varying current and a sinusoidal waveform. With respect to a reference voltage, the AC voltage may have a voltage value on either side of the reference voltage or the AC voltage may be offset from the reference voltage by some direct current (DC) voltage offset. For example, if the reference voltage is zero volts (0 V), the AC voltage may have values on either side of the zero volt reference value. The AC voltage may be supplied directly to the temperature sensing module 200, or be rectified to a DC voltage by additional hardware such as a rectifier (not shown). In one example, the NFC tag 230 may include a rectifier circuit (not shown) to rectify the AC voltage induced in the NFC tag 230 to a direct current (DC) voltage for use by the temperature sensing module 200. Alternatively, in another example, elements in the temperature sensing module 200 such as the control module 220 may include a rectifier circuit to rectify an AC voltage from the NFC tag 230 to a DC voltage.

The voltage induced in the NFC tag 230 can either be stored in the energy storage device 240 or used to directly power elements in the temperature sensing module 200. For example, surplus energy generated by the inductive coupling of the NFC tag 230 and the external transceiver 400 may be stored within the energy storage device 240. In instances where the temperature sensing module 200 and hot plate 300 assembly may change position within the food preparation system 100, the NFC tag 230 may not be within range of an external transceiver 400 for receiving wireless power. In these instances, power stored in the energy storage device 240 may be used to power the temperature sensing module 200. However, in instances where the NFC tag 230 and the external transceiver 400 are within range for transmitting wireless power, the voltage induced in the NFC tag 230 may be used to directly power the temperature sensing module 200 with surplus energy being stored within the energy storage device 240.

The energy storage device 240 may be, for example, one or more chargeable/rechargeable battery cells and/or batteries. The energy storage device 240 may be a rechargeable battery such as a nickel-cadmium battery (Ni—Cd battery) or a Lithium-ion battery (LIB). In another example, the energy storage device 240 may be one or more capacitors or supercapacitors.

The energy storage device 240 may be sized based on the operating environment or operation of the temperature sensing module 200 and hot plate 300 assembly within a food preparation system 100. For example, for a temperature sensing module 200 and hot plate 300 assembly that may move in and out of range of a transceiver 400 during the cooking cycle of a food item, the energy storage device 240 may have a charge capacity that enables the temperature sensing module 200 and hot plate 300 assembly to supply power for the duration of cooking cycle or operation. The size/capacity of the energy storage device 240 may be measured in units such as amp hours (AH) or farads (F).

The temperature sensing module 200 may further include an accelerometer 250. The accelerometer 250 may be a single accelerometer configured to measure acceleration in different directions (e.g., along x-, y-, and z-axes) or one or more accelerometers 250 that measure acceleration in a single direction (e.g., an accelerometer measuring an acceleration along an x-axis, an accelerometer measuring acceleration along a y-axis, and an accelerometer measuring acceleration along a z-axis). When the temperature sensing module 200 is combined with a hot plate 300 as an assembly, the accelerometer 250 may be used to determine the orientation of the hot plate 300. That is, the control module 220 may use data from the accelerometer 250 to determine the orientation of the hot plate 300 within the food preparation system 100.

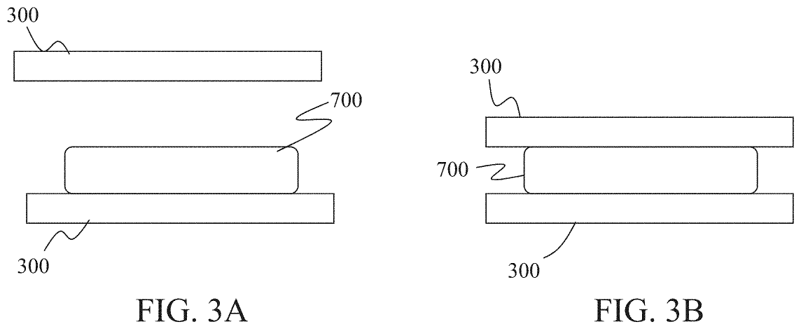

For example, with reference to FIGS. 3A and 3B, when a food item 700 is cooked between two hot plates 300 in a food preparation system 100, one or more of the hot plates 300 may be hinged or arranged to move to allow the hot plates 300 to be opened to an open position to load or remove the food item 700 between the hot plates 300, as shown in FIG. 3A. After positioning the food item 700 between the hot plates 300, the hot plates 300 may move to a closed position, as shown in FIG. 3B, to begin cooking the food item 700.

The accelerometers 250 in each of the temperature sensing modules 200 connected to the hot plates 300 may be used to ascertain the positions of the hot plates 300 relative to each other to determine whether the hot plates 300 are in an open, loading/unloading position, or in a closed, cooking position. By determining the position of the hot plates 300, the control module 220 of the temperature sensing module 200 can determine whether to measure and wirelessly output measurements to the transceiver 400 for temperature control of the hot plates 300. If the control module 220, based on measurements from the accelerometer 250, determines that the hot plates 300 are in an open position, the control module 220 may suspend the operation of the temperature sensing module 200 to conserve power and preserve energy stored in the energy storage device 240.

With reference again to FIGS. 1 and 2, the temperature sensing module 200 may further include the substrate 260. The substrate 260 may be a non-metallic, non-conductive, mechanical support on which the electrical elements in the temperature sensing module 200 are mounted. For example, the substrate 260 may be a printed circuit board (PCB) of a resin, plastic, or like material that mechanically supports the electrical elements such as the control module 220, the NFC tag 230, the energy storage device 240, and the accelerometer 250, in the temperature sensing module 200.

The substrate 260 may further include conductive pathways 262 such as traces, holes, and vias, to electrically connect the electrical elements mounted on the substrate 260. For example, the substrate 260 may mechanically support and electrically connect each of the control module 220, the NFC tag 230, the energy storage device 240, and the accelerometer 250. The wire 212 of the temperature probe 210 may be electrically connected to the one or more conductive pathways 262 on the substrate 260. Each of the wire 212, the control module 220, the NFC tag 230, the energy storage device 240, and the accelerometer 250 may be mechanically bonded to the substrate 260 and conductive pathways 262 by a connector such as electrical solder.

The insulative material of the substrate 260 may also help to insulate the control module 220, the NFC tag 230, the energy storage device 240, and the accelerometer 250 against the heat produced by the hot plate 300. That is, the heat produced by the hot plate 300 may not be readily transferred by the substrate 260 to the control module 220, the NFC tag 230, the energy storage device 240, and the accelerometer 250.

In lieu of, or in addition to, the antenna 232 on the NFC tag 230, the substrate 260 may include a loop-shaped conductive pathway 264 disposed near the edges of the substrate 260 and encircling the control module 220, the NFC tag 230, the energy storage device 240, and the accelerometer 250, as shown in FIG. 1. The conductive pathway 264 may be used as an antenna for receiving communications and magnetic fields from the transceiver 400. For example, a magnetic field generated by the transceiver 400 may induce a voltage in the loop-shaped conductive pathway 264.

The temperature sensing module 200 may further include the frame 270. The frame 270 has three or more side members 272 (e.g., beams or walls), that surround an empty void 274 centrally disposed within the frame 270. The substrate 260 may be disposed within the void 274 and mechanically connected to at least one of the three or more side members 272. When mechanically connected to at least one of the three or more side members 272, the three or more side members 272 surround the substrate 260 positioned within the void 274.

An edge or surface of a side member 272a closest to the hot plate 300 can abut an edge or surface of the hot plate 300. A mechanical fastener (not shown) such as a screw or bolt may be used to attach the frame 270 of the temperature sensing module 200 to the hot plate 300 to form a single assembly.

The frame 270 may be of a heat-resistant metallic material that can resist the heat produced from the hot plate 300. For example, the frame 270 may be made of an aluminum material such as an aluminum alloy. The material selection for the frame 270 may be based on other factors, such as how well the material dissipates heat from the hot plate 300 to other materials in the food preparation system 100 and how well the material limits heat from being transferred to the substrate 260. The geometry of the frame 270 may also be used to limit the heat flow from the hot plate 300 to the temperature sensing module 200. That is, the frame 270 may be constructed with a shape or arrangement that limits the heat transfer from the hot plate 300 to the temperature sensing module 200.

With the substrate 260 positioned within the void 274 and connected to the frame 270, the entirety of the void may be filled with a potting material 275 to encapsulate the control module 220, the NFC tag 230, the energy storage device 240, the accelerometer 250, and the substrate 260 within the potting material 275. The potting material 275 may be of a material that insulates the substrate 260 and the electrical elements mounted thereon from the heat produced by the hot plate 300. The potting material 275 may also insulate the substrate and electrical elements from electricity. The potting material 275 may also limit shock and vibration from acting on the substrate 260 and electrical elements mounted thereon, in addition to excluding water, grease, food, cleaning chemicals, and like things from contacting the substrate 260 and electrical elements mounted thereon. However, the potting material 275 may also be of a material that is transparent to electromagnetic waves. That is, the potting material 275 is of a material that is radio wave transparent (i.e., electromagnetic wave transparent) to allow the NFC tag 230 to output communications to the transceiver 400, and to receive communications and wireless power from the transceiver 400. The potting material 275 may be a thermoset plastic, thermoplastic, silicone rubber, potting epoxy, or like potting materials. For example, the potting material 275 may be polyetherimide (PEI) thermoplastic.

The side member 272a closest to the hot plate 300 may also include a bore 276 through which the wire 212 of the temperature probe 210 can pass to connect to the substrate 260. Likewise, the bore 276 allows the wire and temperature probe 210 to pass through the frame 270 so that the temperature probe 210 can be embedded within the hot plate 300.

The side member 272a closest to the hot plate 300 may also include a pocket 278. The pocket 278 may be an area of the frame 270 where the frame material is removed to create a void, recess, or groove within the frame 270. For example, when the frame 270 is formed, the frame 270 may be cast to include the pocket 278 or the pocket 278 may be milled into the frame 270. The pocket 278 can be filled with a heat resistant insulator (not shown) to further shield the control module 220, the NFC tag 230, the energy storage device 240, the accelerometer 250, the substrate 260, and the potting material 275 from heat produced by the hot plate 300. For example, the heat resistant insulator disposed within the pocket 278 may be silicone rubber.

A gasket 280 may be disposed between the side member 272a closest to the hot plate 300 and the hot plate 300. The gasket 280 may be of a heat resistant material to resist the heat produced from the hot plate 300 and limit the heat transferred from the hot plate 300 to the temperature sensing module 200. For example, the gasket 280 may be of a silicone rubber material.

The material of the frame 270, the potting material 275 within the void 274, the pocket 278 filled with a heat resistant insulating material, and the gasket 280 may all function together as a “heat break” to limit the heat produced from the hot plate 300 from being transferred to the control module 220, the NFC tag 230, the energy storage device 240, and the accelerometer 250. In various implementations, spacers made from a material such as a ceramic may be used as a heat break.

The hot plate 300 includes the channel 302 into which the temperature probe 210 is inserted for measuring the temperature of the hot plate 300. The positioning of the channel 302 within the hot plate 300 and the positioning of the temperature probe 210 within the channel 302 may be based on the operation of the food preparation system 100. An optimal positioning of the temperature probe 210 within the hot plate 300 may depend on the type of heating module 600 used by the food preparation system 100. For example, the positioning of the temperature probe 210 within the hot plate 300 may be different for conductive-type (e.g., electric burner) and induction-type (e.g., induction burner) heating modules 600.

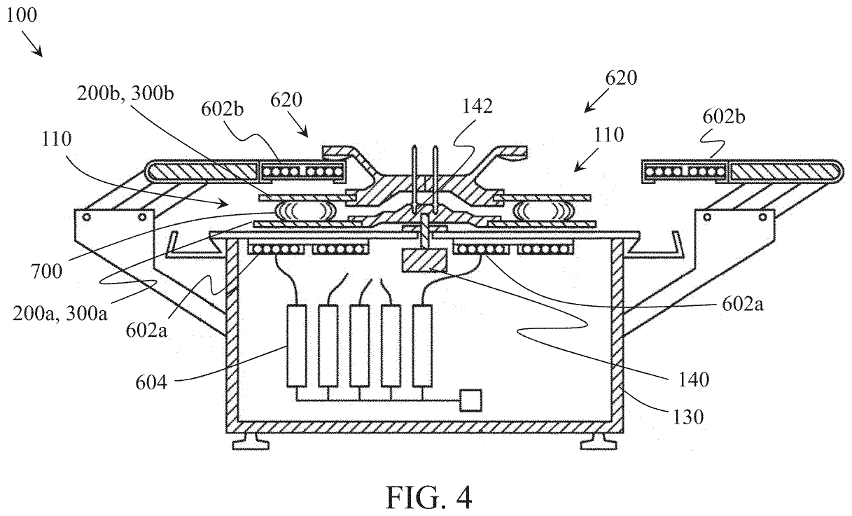

With reference now to FIGS. 4-6, an example food preparation system 100 with induction-type heating modules 600 is shown. When the food preparation system 100 includes induction-type heating modules 600, the hot plates 300 are heated by electromagnetic induction. The heating modules 600 include induction coils 602 that pass an alternating electric current from an induction generator 604 through the induction coils 602 to produce magnetic fields. The magnetic fields produced by the induction coils 602 induce large electrical eddy currents in the material of the hot plates 300. The material of the hot plates 300 resist the flow of the eddy currents to generate resistive heating in the hot plates 300 to cook the food item 700.

With reference again to FIG. 2, the temperature probe 210 is arranged at a position within the channel 302 of the hot plate 300 corresponding to a position on a surface 304 of the hot plate 300 with the largest eddy current flow during the electromagnetic induction heating of the hot plate 300. In other words, the temperature probe 210 is positioned to be directly adjacent to the position on the surface 304 of the hot plate 300 where the eddy current flow is the largest. The position on the surface 304 where the eddy current flow is the highest may not be the center of the hot plate 300, because the inductive heating may occur in a toroid shape radiating in and out throughout the hot plate 300.

By positioning the temperature probe 210 in the channel 302 to correspond to the position on the surface 304 with the largest eddy current flow during induction heating, this ensures that measurements by the temperature probe 210 are consistent. These measurements may then be wirelessly output by the NFC tag 230 for use as inputs by the cooking controller 500 controlling the heating module 600 for more precisely controlling the temperature of the hot plate 300 and more generally, the cooking temperature of a food item cooked by the hot plate 300.

Once the temperature probe 210 is positioned within the channel 302, a portion of the channel 302 or all of the channel 302 may be filled with a thermal paste (not shown) to ensure a thermal connection between the temperature probe 210 and the hot plate 300. For example, the thermal paste filling in the channel 302 may be limited to the area in the channel 302 surrounding the temperature probe 210. When the entirety of the channel 302 is not filled with the thermal paste, the remaining portions of the channel 302 not filled by thermal paste may be filled with additional fillers, for example, materials similar to the above-described potting material 275. The thermal paste 208 is a thermally conductive compound that ensures good heat transfer from the hot plate 300 to the temperature probe 210.

The hot plate 300 may be of a ferrous metal material that can be heated by induction heating. That is, the hot plate 300 may have layer of ferrous metal material, the hot plate 300 may contain some percentage of ferrous metal material, or the hot plate 300 may be made completely from a ferrous metal material with ferrous metal throughout the hot plate 300. The material of the hot plate 300 may also be a thermally conductive material that allows the hot plate 300 to also be heated by indirect heating means such as convection or thermal conduction. For example, the hot plate 300 may be of an aluminum-clad stainless steel material.

The surface 304 of the hot plate may be coated with a non-stick material to limit food from sticking to the hot plate 300 during cooking. For example, the surface 304 of the hot plate 300 may be coated with a Polytetrafluoroethylene (PTFE) coating, also known as Teflon, to limit food from sticking to the hot plate 300 during cooking. Teflon is a registered trademark of the Chemours Company, formerly known as DuPont de Nemours, Incorporated.

With reference now to FIGS. 4-6, an example food preparation system 100 is illustrated. The example food preparation system 100 may be configured to use one or more wireless temperature sensing module 200 and hot plate 300 assemblies—that is, platen assemblies. An example of a food preparation system that can be configured to use the temperature sensing module 200 and hot plate 300 assembly is described in U.S. patent application Ser. No. 16/447,897, filed Jun. 20, 2019, titled “System and Method for Cooking a Food Product,” and assigned to Creator, Inc. of San Francisco, Calif., the entire disclosure of which is incorporated herein by reference.

The example food preparation system 100 may be a system configured to use a plurality of griddle modules 110 to simultaneously cook a plurality of food items 700. For example, the example food preparation system 100 may be configured to simultaneously cook a plurality of meat patties, such as hamburgers.

Each griddle module 110 in the plurality of griddle modules 110 includes a lower hot plate 300a with a temperature sensing module 200a and an upper hot plate 300b with a temperature sensing module 200b. Both the lower hot plate 300a and the upper hot plate 300b are configured to cook different sides of the food item 700. In the example food preparation system 100, where loading and unloading of the food item 700 is automated, the lower hot plate 300a may be configured to first receive the food item 700 and with the upper hot plate 300b arranged over the lower hot plate 300a and configured to contact food item 700, once the food item 700 is loaded onto the lower hot plate 300a for cooking.

The example food preparation system 100 may be further configured to index each of the griddle modules 110 past heating modules 600 as part of an automated cooking process of the food item 700. The heating modules 600 may be configured as a set of induction stations 620 including an entry induction station 621, a plurality of intermediate induction stations 622, and an exit induction station 623. Each of the induction stations 621, 622, and 623 include: a lower coil 602a configured to inductively couple to an adjacent lower plate 300a; and an upper coil 602b configured to inductively couple to an adjacent upper plate 300b.

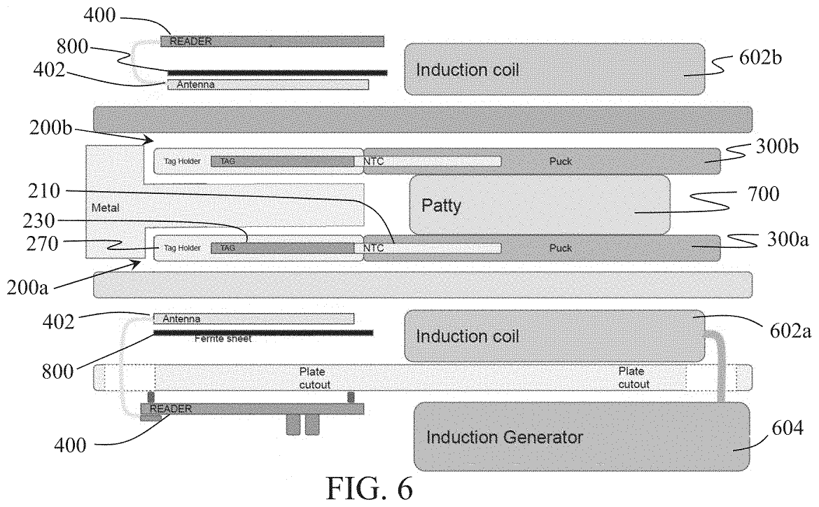

As shown in FIG. 6, various chokes, such as ferrite sheeting 800, may be used to suppress electro-magnetic interference and high frequency noise that may be caused by a plurality of wireless temperature sensing modules 200 operating in close proximity. With a plurality of wireless temperature sensing modules 200 wirelessly transmitting signals, the ferrite sheeting 800 may be used to better control the radio-frequency energy in the example food preparation system 100, and limit and/or prevent crosstalk between different wireless temperature sensing modules 200 and their corresponding respective transceivers 400. In addition to ferrite sheeting 800, other chokes may be used, such as ferrite beads on any AC lines to the induction coils 602 and induction generator 604 to further limit noise and interference from the induction hardware.

Due to the amount of metallic enclosures in the food preparation system 100, the ferrite sheeting 800 can be conformed to the geometry of the metallic enclosures to optimize the RF field shape between the NFC tag 230 and the transceiver 400 to ensure consistent coupling for RF communication, repeatable coupling time, and to avoid signal loss.

The griddle module 110 including a set of platen assemblies with wireless temperature sensing modules 200a, 200b, respectively connected to lower and upper hot plates 300a, 300b along with the heating modules 600 (e.g., induction coils 602 and induction generator 604), for example, as shown in FIG. 6, may be referred to as a hot plate system.

The example food preparation system 100 also includes a base 130 to house the lower induction coils 602a for each of the induction stations 620 and a motor 140 for rotating a hub 142. The base 130 may also be used to house one or more transceivers 400 and the cooking controller 500.

The hub 142 can attach each of the griddle modules 110 and index (i.e., rotate) the griddle modules 110 to rotate the griddle modules from induction station 620 to induction station 620. While the example food preparation system 100 can rotate the griddle modules 110 about an axis of the hub 142, the griddle modules 110 may be configured to rotate about one or more axes as well. For example, each of the griddle modules 110 may rotate about an axis of the griddle module 110 similar to how the hub 142 rotates. For example, when the heating modules 600 of the food preparation system 100 are arranged to only heat a portion of the food item 700 on the griddle module 110 or heat a portion of the hot plate 300, the griddle module 110 may be arranged to rotate to ensure that all of the food item 700 and/or the hot plate 300 is heated by the heating module 600. In this example, the heating module 600 may be arranged as a high temperature broiler or rotisserie where only a portion of the food item 700 and/or hot plate 300 is exposed to the heating module 600 during the rotation of the griddle module 110. The griddle module 110 may also be arranged to rotate about a different axis of the griddle module 110. That is, the griddle module 110 may be arranged to “flip.” For example, when cooking a fluid food item such as eggs or a liquid batter for waffles or pancakes, the griddle module 110 may flip to ensure the liquid food item 700 is distributed and cooked and/or heated evenly within the griddle module 110.

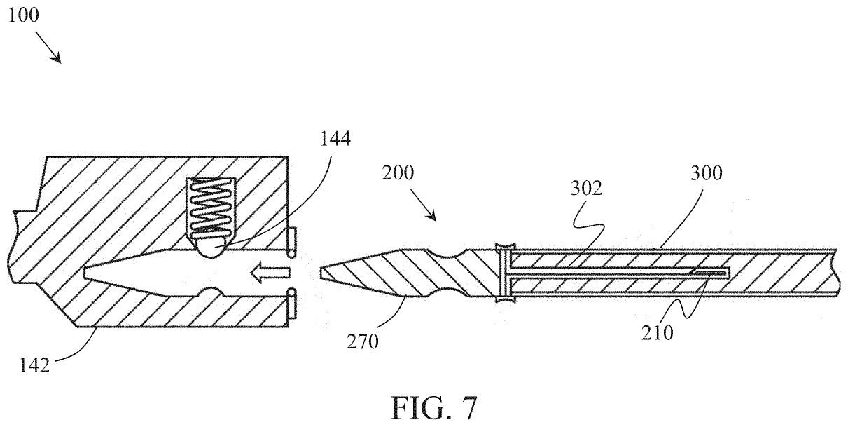

With reference to FIG. 7, the temperature module 200 and hot plate 300 assembly may attach to the hub 142 using a mechanical connector 144. For example, the temperature module 200 and hot plate 300 assembly may attach to the hub 142 with a spring detent that acts as the mechanical connector 144. The spring detent may engage a portion of the frame 270 on the temperature module 200 to hold the temperature module 200 and hot plate 300 assembly in place on the hub 142. While each of the platen assemblies including the temperature module 200 and hot plate 300 can be designed symmetrically for use in either the lower or upper hot plates 300a, 300b, in instances where the platen assemblies are not universal (e.g., asymmetrical design), with dedicated platen assemblies for the lower hot plates 300a and dedicated platen assemblies for the upper hot plates 300b, the platen assemblies may include additional poka-yokes to ensure proper installation of the platen assemblies to the hub 142.

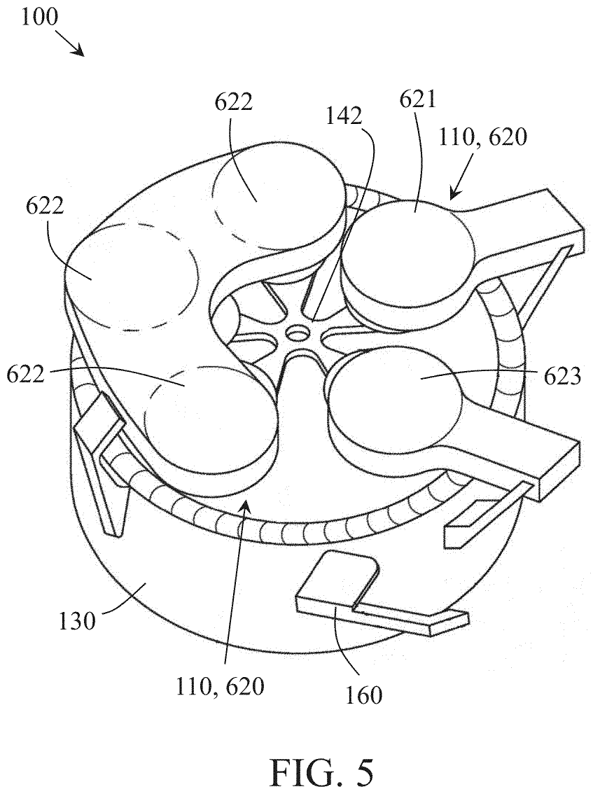

With reference again to FIGS. 4 and 5, the hub 142 rotates counterclockwise to move a food item 700 from the entry induction station 621, through the intermediate induction stations 622, and to the exit induction station 623. The cooking controller 500 may also be used to control the motor 140 and thus the rotation of the hub 142.

The example food preparation system 100 further includes: a retrieval system including a paddle 160 to collect a food item 700 from the lower hot plate 300a once the griddle module 110 reaches the exit induction station 623.

After the example food preparation system 100 for cooking a food item 700 receives a food item 700 between the lower and upper hot plates 300a, 300b of a griddle module 110, the example food preparation system 100 may compress the food item between the lower and upper hot plates 300a, 300b of the griddle module 110, sequentially advance the griddle module 110 through each induction station 621, 622, 623 in a set of induction stations 620, and sequentially power lower and upper induction coils 602a, 602b of each induction station 620 based on the position of the griddle module 110 to heat the lower and upper hot plates 300a, 300b of the griddle module 110, thereby heating (e.g., cooking) the food item 700. The example food preparation system 100 can then remove the food item from the griddle module 110 once the griddle module 110 has entered or passed through a last induction station 623.

As shown in FIG. 5, the food preparation system 100 can also include a set of (e.g., five) griddle modules 110, such as one griddle module for each induction station. For example, the example food preparation system 100 can receive a first item 700 product at a first griddle module 110 arranged in an entry induction station 621 while a second, a third, and a fourth food item 700 are heated between the lower and upper hot plates 300a, 300b of second, third, and fourth griddle modules 110 in second, third, and fourth induction stations 622, respectively, and while a fifth food item 700 is removed from a fifth griddle module 110 in an exit induction station 623. In this example, once the first food item 700 is inserted into the first griddle module 110 and initially heated in the first induction station 621, the food preparation system 100 can deactivate all coils 602a, 602b in all induction stations 620 before indexing the griddle modules 110 forward in order to position the first griddle module in the second induction station 622, to position the second griddle module in the third induction station 622, to position the third griddle module in the fourth induction station 622, to position the fourth griddle module in the exit induction station 623, and to position the fifth griddle module in the entry induction station 621.

In the above example, as the second induction station 622 heats the first food item 700 between the lower and upper hot plates 300a, 300b of the first griddle module 110, the example food preparation system 100 can place a sixth food item 700 into the fifth griddle module 110 in the entry induction station 621 and remove the fourth food item 700 from the fourth griddle module 110 in the exit induction station 623. The example food preparation system 100 can then repeat this process over time to continuously receive food items at griddle modules in the entry induction station, to sequentially heat (or cook) food items 700 from the entry induction station 621 through the exit induction station 623, and to retrieve heated (or cooked) food items 700 from griddle modules 110 in the exit induction station 623. In this example, the example food preparation system 100 can receive a sequence of hamburger patties from a patty grinding system (not shown), sequentially insert hamburger patties into griddle modules 110 in the entry induction station 621, simultaneously cook multiple hamburger patties to various doneness levels at each induction station 620, and remove done hamburger patties from griddle modules at the exit induction station 623.

The example food preparation system 100 can also modulate a power output at each induction station 620 in order to achieve a target doneness for the food item 700. For example, when the griddle module 110 in the entry induction station 621 receives a hamburger patty assigned a medium doneness level, the cooking controller 500 of the example food preparation system 100 can implement closed-loop feedback techniques using measurements from the hot plates 300 sent wirelessly via the temperature sensing modules 200 to modulate the power outputs of the lower and upper coils 602a, 602b in the entry induction station 621 based on measurements of the temperature probes 210 embedded in the lower and upper hot plates 300a, 300b in the griddle module 110, in order to maintain a target entry stage temperature for a medium doneness level of the food item 700. In this example, once the griddle module is indexed to a second induction station 622, the cooking controller 500 can again implement closed-loop feedback techniques using measurements sent wirelessly via the temperature sensing modules 200 to modulate the power outputs of the lower and upper coils 602a, 602b in a second induction station 622 based on outputs of temperature probes 210 embedded in the lower and upper hot plates 300a, 300b in the griddle module 110 in order to maintain a target second stage temperature of the food item 700 for a medium doneness level. In this example, the example food preparation system 100 can repeat this process until the hamburger patty is fully cooked to a medium doneness level at the exit induction station 623.

Upon completion of a cook cycle at a griddle module 110 (i.e., upon advancement of the griddle module 110 from the entry induction station 621 through to the exit induction station 623), the example food preparation system 100 can then remove a heated or cooked food item 700 from the griddle module 110. For example, when the food item 700 is a hamburger patty, the food preparation system 100 can remove the hamburger patty from a griddle module 110 in the exit induction station 623 and dispense the hamburger patty onto a hamburger bun nearby in preparation for delivering a completed hamburger to a patron according to a custom hamburger order recently submitted by the patron.

By combining a temperature sensing module 200 to each of the hot plates 300 in the griddle modules 110, the temperature sensing module 200 with a temperature probe 210 embedded in a hot plate 300 provides the ability to measure cooking temperature as close to the cooking source (i.e., the hot plate 300) as possible for better closed-loop cooking control. That is, by taking a temperature measurement close to the cooking surface 304 of the hot plate 300 in contact with the food item 700, the cooking controller 500 can better execute closed-loop feedback cooking techniques using temperature measurements from temperature probes 210 in each of the hot plates 300 to better modulate the induction coils 602 to better control the cooking temperature of the hot plates 300, and more specifically the cooking temperature of the food item 700.

Additionally, as the temperature sensing module 200 and the platen assembly including the temperature sensing module 200 and the hot plate 300 are sealed with potting material and do not include any external wires or connectors, the temperature sensing module 200 and platen assembly has a more streamlined enclosure with fewer surfaces for harboring food particles, bacteria, or other contaminants. That is, a platen assembly including the temperature sensing module 200 and hot plate 300 may be more easily removed from a food preparation system 100 for cleaning, without a user having to worry about exposing the electrical components of the temperature sensing module 200 and embedded within the hot plate 300 to water and cleaning chemicals.

In addition to closed-loop feedback control, temperatures captured by the wireless temperature sensing module 200 may be used to monitor the temperature of the hot plate 300, so as to protect against over-temperature events and other malfunctions that may occur in the hot plate 300.

Additionally, the temperatures measured by the wireless temperature sensing module 200 may be stored in a database or other storage. Such temperature data may be used for calibrating a food preparation system 100. Regulatory agencies such as the Food and Drug Administration (FDA), National Sanitation Foundation (NSF), health inspectors, and other agencies may also use the stored temperature data to ensure that a food vendor is properly preparing food cooked on a food preparation system 100.

While an example embodiment of a food preparation system 100 is described above, the food preparation system 100 is not limited to the example embodiment. For example, the food preparation system 100 using the wireless temperature sensing module 200 and hot plate assembly is not limited to preparing meat patties such as hamburgers, but may also be used to cook or heat: vegetable patties; raw patties of ground fish, poultry, pork, lamb, or bison, etc.; raw beef, fish, bison, lamb, chicken, etc.; steaks; cooked or uncooked sausage; and/or any other raw, semi-cooked, or cooked food product of any other geometry, and can dispense such a food product onto any other cooking surface, heating surface, hamburger bun, bread slice, bed of greens, plate, bowl, or other container or surface upon completion of a cook cycle. The food preparation system 100 using the wireless temperature sensing module 200 and hot plate 300 assembly may also be used to prepare other food items such as pizza, bread, other baked goods, crepes, waffles, pancakes, eggs, omelets, vegetables, soups, coffee, tea, fried foods, boiled foods, sautéed foods, grilled foods, broiled foods, roasted foods, and the like.

While example embodiments of a food preparation system 100 using the wireless temperature sensing module 200 and hot plate 300 assembly have been described, the wireless temperature sensing module 200 may also be combined with a cold plate for closed-loop temperature control when preparing or cooling cold food items such as ice cream, frozen foods, beverages, and like food items. That is, the hot plate 300 may be configured as a cold plate with the plate 300 in contact with a cooling device or substance such as a heat pump, vapor-compression device, coil, water, ice, liquid nitrogen, and the like cooling means.

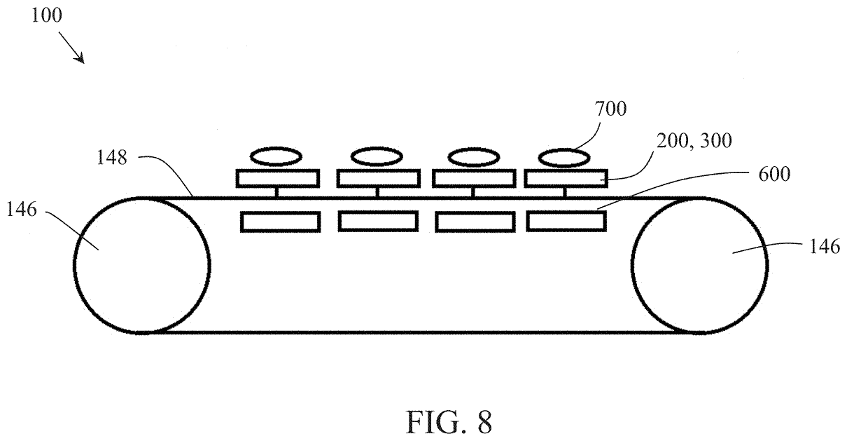

With reference to FIG. 8, another example food preparation system 100 is illustrated. In another example embodiment, the food preparation system 100 may use linear motion to move a plurality of wireless temperature sensing module 200 and hot plate 300 assemblies with food items 700 from one heating module 600 to the next. In this example embodiment, a motor (not shown) may rotate one or more rollers 146 to drive a belt 148 to move the wireless temperature sensing module 200 and hot plates 300 from one heating module 600 to another. In other words, a conveyor belt type system with the belt 148 may be used to move the wireless temperature sensing module and hot plate assemblies 300 in a linear motion for cooking/heating food at different heating modules 600.

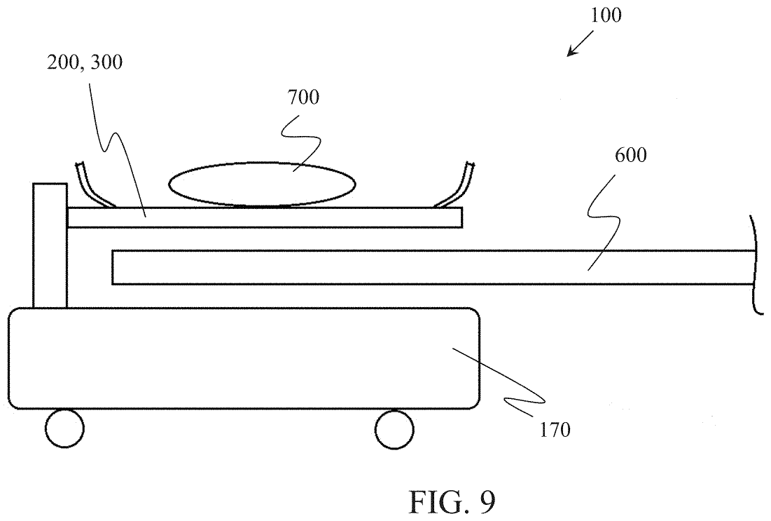

With reference to FIG. 9, another example food preparation system 100 is illustrated. In another example embodiment, the food preparation system 100 may use autonomous robotics such as a cart 170 to move a wireless temperature sensing module 200 and hot plate 300 assembly with a food item 700 to a heating module 600. The cart 170 may be programmed to position the wireless temperature sensing module 200 and hot plate 300 assembly relative to the heating module 600 to cook/heat the food item 700. While the heating module 600 is shown underneath the wireless temperature sensing module 200 and hot plate 300 assembly in FIG. 9, other example embodiments of the food preparation system 100 may include different arrangements of the heating module 600. For example, the heating module 600 may be arranged to be positioned above the wireless temperature sensing module 200 and hot plate 300 assembly with the cart 170 moving the food item 700 underneath the heating module 600 to be cooked/heated.

While example embodiments described herein may use heating modules 600 configured for induction cooking, the heating module 600 is not limited to an induction cooking arrangement. For example, the heating module 600 may be a gas burner or an electric burner such as an electric plate, electric coil, glass-ceramic halogen burner, and like burner arrangements. The heating module 600 may be configured in arrangements other than a burner/hob. For example, the heating module 600 may be arranged in a grill, griddle, fryer, kettle, oven, broiler, and like cooking means.

Other example embodiments of food preparation systems 100 where a food item is heated from a heating module 600 other than an induction heating module and/or heated where the food item is not in contact with the hot plate 300 may arrange the temperature probe 210 at different positions within the hot plate. That is, at positions other than positions corresponding to the largest eddy current flow when the hot plate is heated by an induction heating module 600. For example, when a hot plate 300 is heated by a heating module 600 arranged as a gas or electric burner where the hot plate 300 is in contact with the heating module 600, the temperature probe 210 may be arranged at a location within the hot plate 300 corresponding to a position on the surface 304 of the hot plate 300 where the food item 700 contacts the hot plate. A temperature model of the hot plate 300 may be used to determine the optimum position of the temperature probe 210 within the hot plate 300 and thus the optimum position for cooking/heating the food item 700 on the hot plate 300. In another example where the heating module 600 may be arranged as a broiler and the hot plate 300 is not in contact with the heating module 600, the temperature probe 210 may be positioned within the hot plate 300 at a position to best determine the temperature of the heat radiated by a broiler heating module 600. For example, the temperature probe 210 may be positioned at a location within the hot plate 300 where the heat from broiler heating module 600 is not blocked by the cooking of the food item 700. In other words, at a position within the hot plate 300 that does not correspond to a position of the food item on the surface 304 of the hot plate 300.

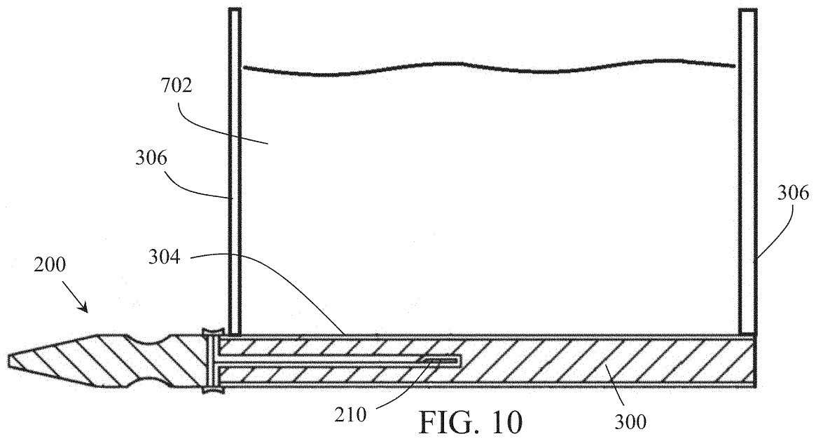

With reference to FIG. 10, an example wireless temperature sensing module 200 and hot plate 300 is illustrated. An example hot plate 300 may be arranged to have walls 306 like a cooking pot for holding a liquid or semi-liquid food item 702. That is, the hot plate 300 may be configured for cooking more fluid foods and beverages such as soups, sauces, stews, and hot drinks such as coffee and tea. Like other example embodiments, the temperature probe 210 of the wireless temperature sensing module 200 is used to measure a temperature of the surface 304 of the hot plate 300. The temperature measurement can be used with a cooking system having closed-loop feedback control to better regulate the temperature of the surface 304 of the hot plate 300, and thus better regulate the cooking/heating of the liquid food item 702 in contact with the hot plate 300.

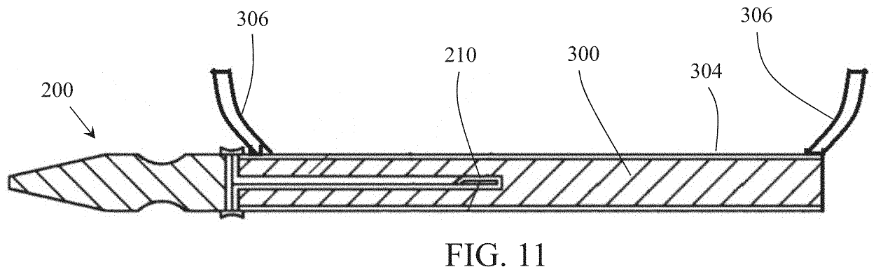

With reference to FIG. 11, another example wireless temperature sensing module 200 and hot plate assembly 300 is illustrated. An example hot plate 300 may be arranged to have walls 306 like a cooking pan for containing food items. For example, when the wireless temperature sensing module 200 and hot plate assembly is arranged to move from one heating module to another, lightweight, rounded, and fluid food items may move about the hot plate 300 as the wireless temperature sensing module 200 and hot plate 300 assembly moves from heating module to heating module. For example, the walls 306 may be used to contain food items such as eggs, meatballs, whole and sliced vegetables and fruits, and like food items on the hot plate 300.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A temperature sensing device for a heating surface for food products, the temperature sensing device comprising:
a temperature probe configured to be coupled to the heating surface and to generate an electrical signal indicative of a temperature of the heating surface;
a controller in electrical communication with the temperature probe; and
a wireless transmitter in electrical communication with the controller, wherein:
the controller is configured to read the electrical signal from the temperature probe and to provide an output signal to the wireless transmitter,
the wireless transmitter is configured to wirelessly transmit a temperature signal to a transceiver based on the output signal,
the wireless transmitter is configured to wirelessly receive energy, and
the controller is configured to be powered by the received energy from the wireless transmitter.

2. The temperature sensing device of claim 1 wherein the wireless transmitter is configured to:
while the heating surface is in a first location, selectively wirelessly transmit the temperature signal to the transceiver and selectively wirelessly receive energy from a first power source; and
while the heating surface is in a second location, selectively wirelessly transmit the temperature signal to a second transceiver and selectively wirelessly receive energy from a second power source.

3. A food heating system comprising:
the temperature sensing device of claim 2;
the heating surface;
the transceiver, wherein the transceiver is located proximate to the first location; and
the second transceiver, wherein the second transceiver is located proximate to the second location.

4. The food heating system of claim 3 wherein:
the transceiver is configured to operate as the first power source; and
the second transceiver is configured to operate as the second power source.

5. The food heating system of claim 3 further comprising:
a first inductive energy generator configured to selectively heat the heating surface while the heating surface is in the first location; and
a second inductive energy generator configured to selectively heat the heating surface while the heating surface is in the second location.

6. The food heating system of claim 5 wherein:
the first inductive energy generator is configured to operate as the first power source; and
the second inductive energy generator is configured to operate as the second power source.

7. The temperature sensing device of claim 1 wherein the wireless transmitter is configured to wirelessly receive the energy from the transceiver.

8. The temperature sensing device of claim 1 wherein:
the heating surface is heated by an inductive energy source, and
the wireless transmitter is configured to wirelessly receive the energy from the inductive energy source.

9. The temperature sensing device of claim 1 wherein the wireless transmitter includes a near-field communication (NFC) tag.

10. The temperature sensing device of claim 9 wherein:
the wireless transmitter includes an antenna that is configured to be inductively excited by an electromagnetic field generated by one of the transceiver and an inductive energy generator; and
the received energy is based on a voltage generated by the inductive excitation of the antenna.

11. The temperature sensing device of claim 1 further comprising an energy storage device configured to temporarily store at least a portion of the received energy.

12. The temperature sensing device of claim 1 further comprising:
a frame configured to mechanically couple to the heating surface,
wherein the frame supports the controller and the wireless transmitter.

13. The temperature sensing device of claim 12 further comprising a heat-resistant gasket disposed on a surface of the frame between the heating surface and the surface of the frame.

14. The temperature sensing device of claim 12 wherein:
the frame has a bore extending through one face of the frame; and
the bore is configured to allow the temperature probe to pass through the frame and into an opening in the heating surface.

15. The temperature sensing device of claim 1 further comprising:
an accelerometer,
wherein the controller is configured to (i) determine an orientation of the heating surface based on data from the accelerometer and (ii) control the wireless transmitter to wirelessly transmit information to the transceiver that indicates the determined orientation.

16. A heating apparatus comprising:
the temperature sensing device of claim 1; and
the heating surface, wherein the heating surface is configured to be heated by an external energy source.

17. The heating apparatus of claim 16 wherein:
the heating surface includes a ferrous metal material; and
the heating surface includes a channel extending into the ferrous metal material that receives the temperature probe.

18. The heating apparatus of claim 17 wherein the heating surface is configured to be heated by electromagnetic induction excited by an inductive energy generator.

19. The heating apparatus of claim 18 wherein:
the wireless transmitter includes an antenna configured to be excited by the inductive energy generator; and
the excitation of the antenna produces the received energy.

20. The heating apparatus of claim 18, wherein:
the temperature probe is most sensitive to temperature changes at a measurement region of the temperature probe; and
the channel extends to dispose the measurement region of the temperature probe adjacent to a location on the heating surface where a largest eddy current flows in the heating surface during the electromagnetic induction.
